(19) United States
(12) Patent Application Publication
(10) Pub. No.: US 2024/0054145 A1
(43) Pub. Date: Feb. 15, 2024

(54) Object Lineage Analysis For Package Transport

(71) Applicant: SAP SE, Walldorf (DE)

(72) Inventors: Sahana Durgam Udaya, Bangalore (IN); Pranav Kumar, Bangalore (IN); Abhishek Nagendra, Bangalore (IN)

(21) Appl. No.: 17/885,078

(22) Filed: Aug. 10, 2022

(51) Int. Cl. G06F 16/26; G06F 16/22; G06F 16/28

(52) U.S. Cl. CPC G06F 16/26; G06F 16/2246; G06F 16/2282; G06F 16/288

(57) ABSTRACT

Efficient transport of content packages comprising multiple objects, is achieved utilizing lineage analysis. User selection of an object in a package, triggers a dependency request to a landscape containing the object. The landscape returns a dependencies result, which includes dependencies between the selected object and others present within the landscape. The dependencies result is used to create a dependents tree structure. Based upon the dependents tree and the originally selected object, a lineage view is created and afforded to the user. Example lineage views may comprise spider charts with the selected object at the center. The user may further explore object dependencies by interacting with the lineage view to create other lineage views. Providing intuitive visualization of object dependencies, aids in efficient package transport (e.g., by allowing a user to identify dependent object(s) missing from the package, and/or particular objects having many dependent objects that also require transport).

### BACKGROUND

Unless otherwise indicated herein, the approaches described in this section are not prior art to the claims in this application and are not admitted to be prior art by inclusion in this section.

Multiple software applications are increasingly subject to complex deployments in one or more cloud environments. In one possible example, software used to perform analytics upon current activity, may need to efficiently communicate with separate applications relating to availability of resources and forecasting of future activity.

Analytics content may take several forms, including but not limited to models, stories, and visualizations. Effectively sharing such analytics content across different landscapes in the form of packages, can play a central role in permitting the discovery of unseen patterns in order to boost future productivity.

### SUMMARY

Efficient transport of content packages comprising multiple objects, is achieved utilizing lineage analysis. User selection of a constituent object (e.g., model; story; team) of a package, triggers a dependency request to a landscape containing the object. The landscape returns a dependencies result, which includes dependencies between the selected object and other objects present within the landscape. The dependencies result is used to create a dependents tree structure. Based upon the dependents tree and the originally selected object, a lineage view is created and afforded to the user. In one example, the lineage view may comprise a spider chart with the selected object being located at the center. The user may further explore and visualize object dependencies by interacting with the original lineage view to create additional lineage views. Providing intuitive visualization of dependencies between objects of a landscape, aids in efficient package transport—e.g., by allowing a user to identify dependent object(s) missing from the package, and/or particular objects having many dependent objects that also require transport.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 1A shows a simplified view of a package import. FIG. 1B shows a simplified view of a package transport.

FIG. 2 shows a simplified flow diagram of a method according to an embodiment.

FIG. 3 shows an overview of a system according to an example.

FIG. 4 shows an example content package.

FIG. 5 shows sample content package metadata.

FIGS. 6-8 show examples of different object dependencies.

FIG. 9 shows a process flow for content package creation and export.

FIG. 10 shows a process flow for content package import.

FIG. 11 shows a process flow for lineage analysis according to an embodiment.

FIG. 12 is an example screenshot showing selection of an object.

FIG. 13 is an example screenshot showing a dependency request.

FIGS. 14A-B show an example dependency calculation result.

FIG. 15 shows an example of a dependents tree structure.

FIG. 16 is a flow diagram showing creation of a dependents tree structure.

FIGS. 17-18C show example spider charts as lineage views.

FIG. 19 illustrates hardware of a special purpose computing machine configured for implementing lineage analysis according to embodiments.

FIG. 20 illustrates an example computer system.

### DETAILED DESCRIPTION

Described herein are methods and apparatuses that perform lineage analysis in the transport of packages. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

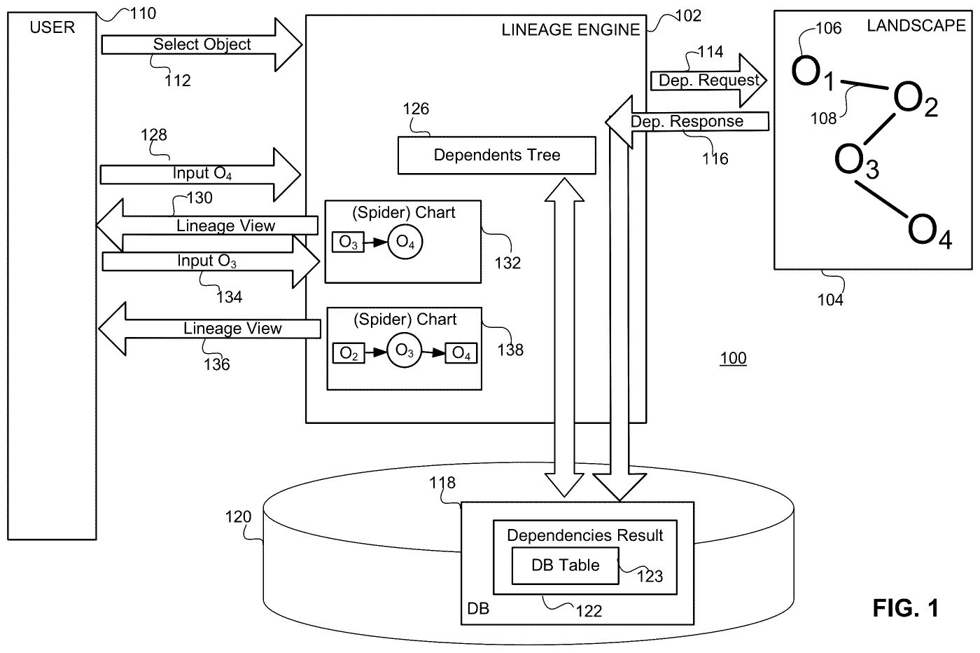

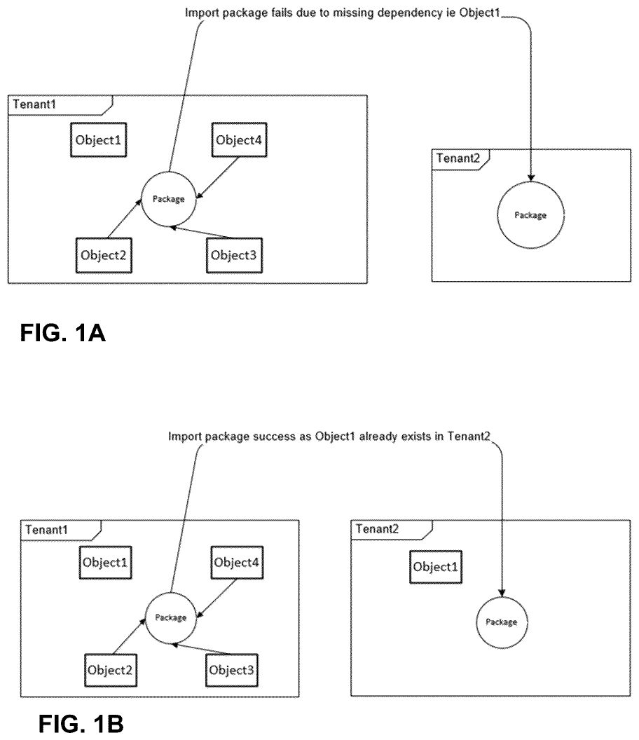

FIG. 1 shows a simplified view of an example system that is configured to implement object lineage analysis according to an embodiment. Specifically, lineage engine 102 is in communication with a landscape 104 comprising different objects (Oₙ) 106 that are linked by dependencies 108. Examples of such objects can include but are not limited to stories, models, analytics applications, as well as other individual artifacts are associated with content.

User 110 seeks to create a package comprising selected objects, and to transport that package to another entity. For example, the user may seek to share the content package relating to an analytical conclusion, with a team of collaborators in order to obtain their feedback as to that conclusion.

Accordingly, the user communicates an object selection 112 to the lineage engine. In response to the selection, the lineage engine communicates a dependencies request 114 to the landscape.

In turn, the landscape returns to the lineage engine, a dependency response 116 indicating dependencies between objects within the landscape. That dependency response is received by the lineage engine, and stored in a database 118 (e.g., in a non-transitory computer readable storage medium 120) as a dependencies result 122 comprising database table(s) 123.

Next, the lineage engine references the dependencies result in order to create a hierarchical representation of the objects and their dependencies. According to one particular embodiments, the lineage engine constructs a dependents tree 126 comprising various (e.g., root; leaf) nodes.

Next, the user selects 128 one of the objects of the dependencies result. In FIG. 1, for example, the object O₄ is selected.

Then, the lineage engine processes the dependents tree to produce a view of the selected object and its lineage (e.g., dependency upon other objects). For particular embodiments, this lineage view 130 may be in the form of a spider chart 132, with a selected object positioned at its center, and dependent objects located at its periphery.

The user receives and examines the initial lineage view. The user is then free to further explore dependency relations between objects, by selecting 134 other objects within the lineage view.

Such input in turn results in the lineage engine creating and presenting to the user, a follow-up lineage view 136. In an example, that additional lineage view may comprise a spider chart 138.

This spider chart presents the selected other object at the center, with other objects dependent thereon being presented at the periphery. Here, the arrow pointing towards the center object indicates that O₂ depends on O₃—i.e., O₃ dependents. The arrow pointing away from the center object indicates that O₃ depends on O₄—i.e., O₃ dependency. This visualization helps in analyzing dependency and dependents, facilitating dependency and impact analysis.

The insight that is rapidly and intuitively afforded to the user through lineage analysis, can be beneficial in attempts to effectively transport a package including its constituent objects. For example, FIG. 1A shows that absent accurate knowledge of dependencies between content objects, the user is at risk of having a package import fail due to a missing object.

Having accurate knowledge of object dependencies can also desirably serve to conserve resource consumption. For example, FIG. 1B shows that a user may be able to reduce a size of a package that is transported, owing to lineage knowledge that an object (e.g., object 1) already exists in a target landscape and hence does not need to be included.

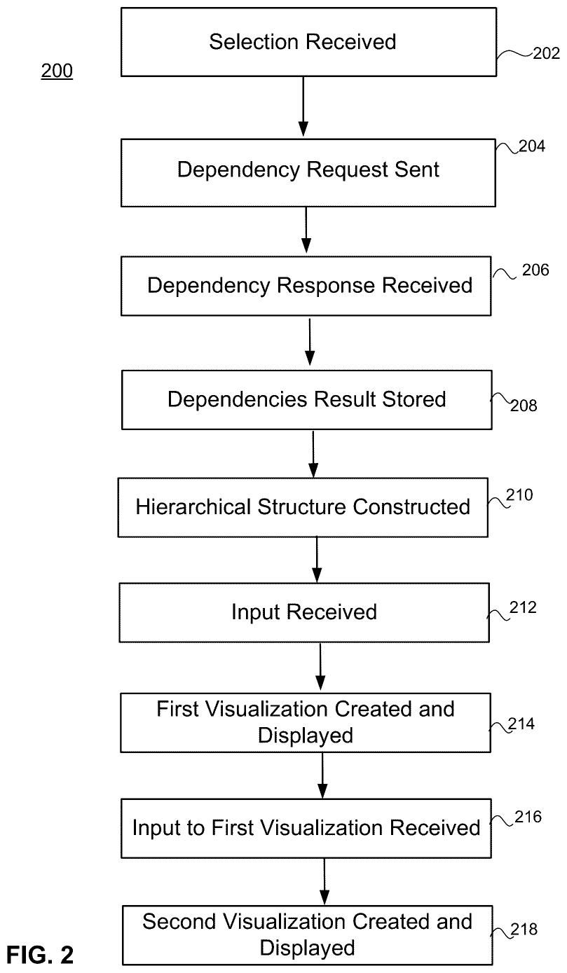

FIG. 2 is a flow diagram of a method 200 according to an embodiment. At 202, a selection of an object in a landscape is received.

At 204, a dependency request is sent to the landscape. At 206, a dependency response is received from the landscape.

At 208, the dependency response is stored as a dependencies result. At 210, a hierarchical structure is constructed from the dependencies result.

At 212 an input is received. At 214, in response to the input a first visualization is created and displayed.

At 216 another input is received to the first visualization. At 218, in response to the another input, a second visualization is created and displayed.

Further details regarding content object lineage analysis according to various embodiments, are now provided in connection with the following example.

### EXAMPLE

An example of an embodiment of performing lineage analysis of objects for package transport is now described in connection with the SAP Analytics Cloud (SAC) available from SAP SE of Walldorf, Germany.

SAC is deployed in the cloud, and combines analytics, planning, and predictive capabilities. In an analytics application, the analytics content can take various forms, including but not limited to:
model,
story,
visualizations,
Value Driver Tree (VDT), and
others.

Having this analytics content available can play an important role in discovering the unseen patterns to boost productivity. Hence sharing of the analytics content across users (e.g., in the form of packages) is helpful to promote collaboration. Moreover, the standard content template can be reused by all user by plugging in their corresponding data.

The Analytical Content Network (ACN) is the infrastructure for sharing analytics content in SAC. A package is the content entity that contains SAC content to be shared.

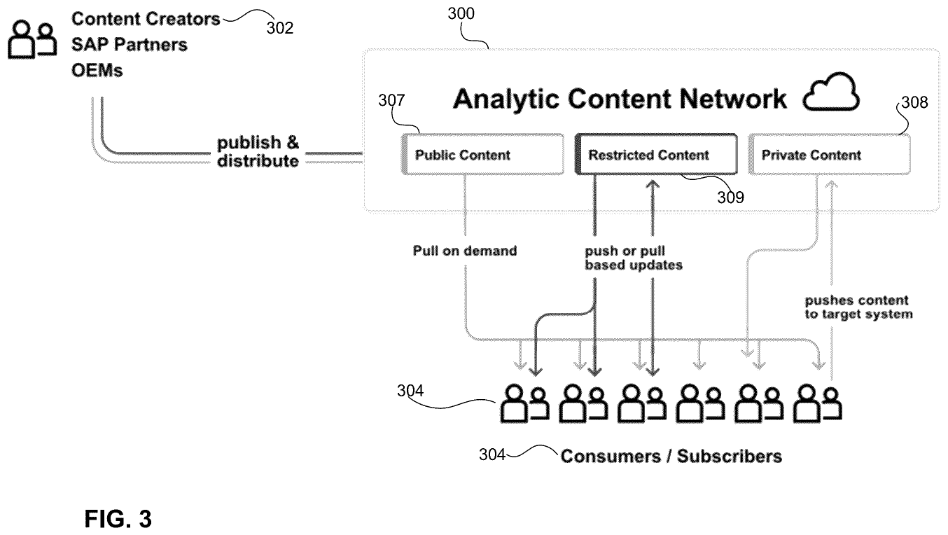

FIG. 3 shows a simplified view of ACN 300. The ACN resides in SAC landscapes as a central component, connected to other components.

So, logically the ACN functions as one global content network which can provision or share SAC content. The ACN is connected out-of-the-box to any SAC tenant, and hence can provision and share content into the SAC tenant.

ACN supports various end-user workflows. In one workflow, a SAC content creator 302 creates SAC content in the form of stories, models, dimensions, connections, VDTs, and others. If authorized, the content creator can then export this content from the SAC tenant to ACN by creating a content package containing any number of these content items, and then share this content with multiple other tenants.

According to another workflow, a SAC content user 304 can view available content packages in their listing, and import relevant packages for their analytic workflows. This includes Public content 307 (e.g., Templates or Demo content) and Private Content 308 (content shared privately with that content user). The content can also be of a restricted type 309, e.g., falling under national privacy rules.

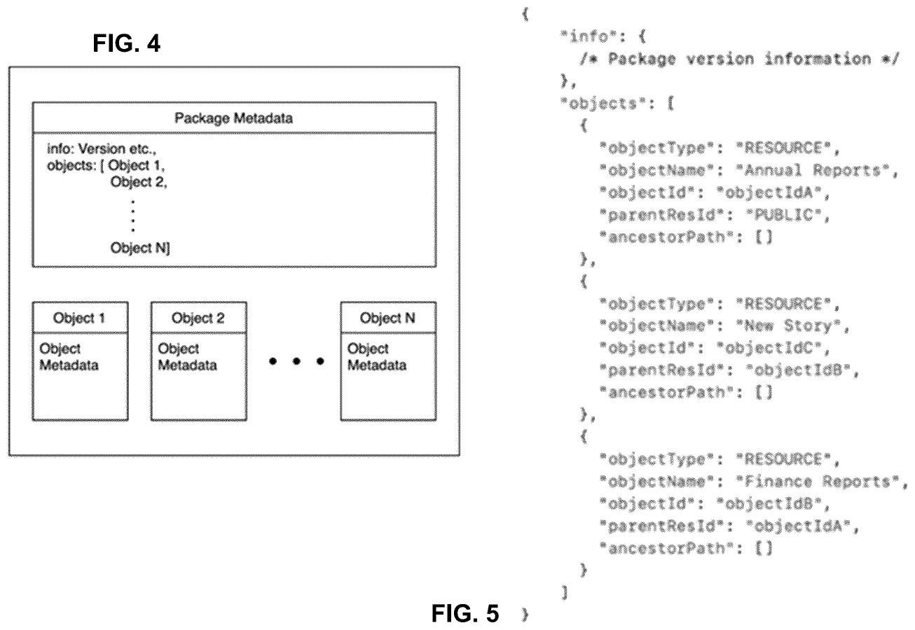

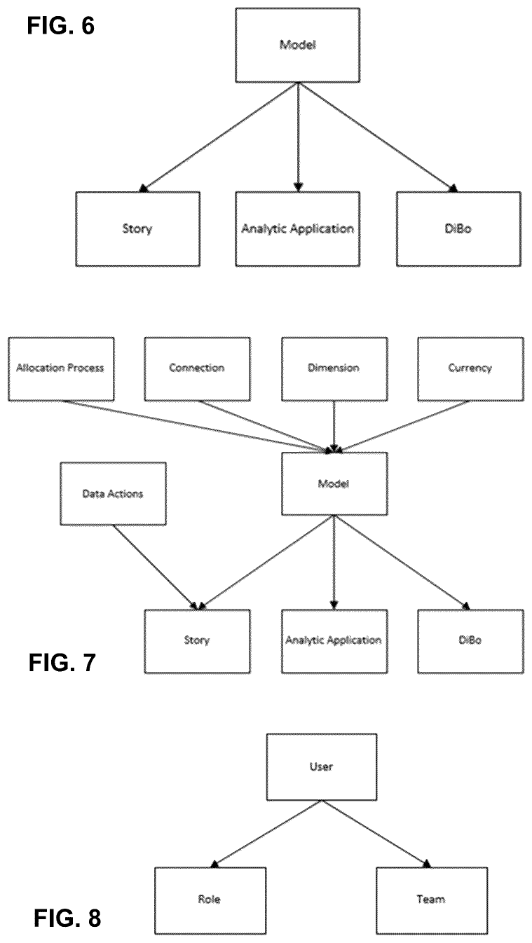

FIG. 4 shows a simplified view of a sample package. FIG. 5 shows sample package metadata. A SAC package may include:
details of each object present in the package,
dependency information between those objects,
an overview summarizing content details.

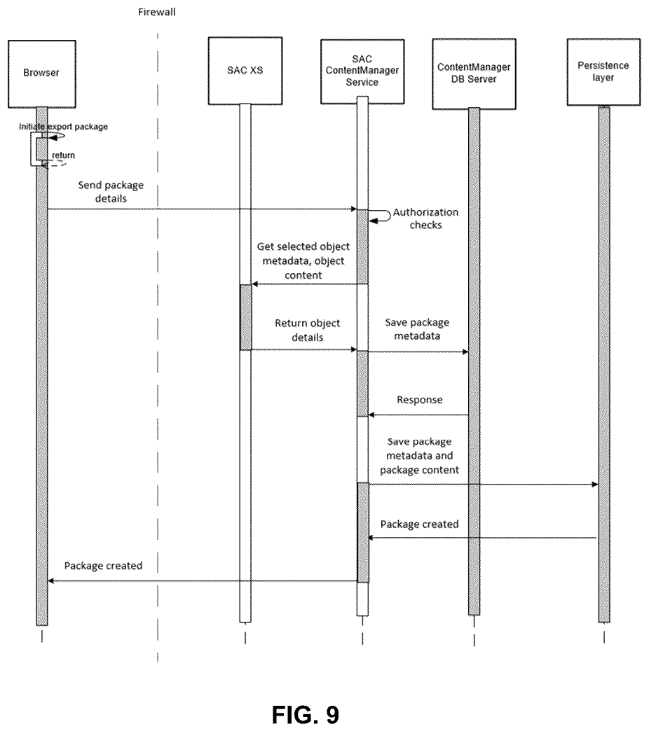

A variety of different types of packages may be created for export. Such packages may exhibit different dependencies between different objects. For example, FIG. 6 shows a package comprising a model object and its impact upon other objects (story object, analytical application, Digital Boardroom—DiBO) of a package.

While the example of FIG. 6 shows only two levels, this is simplified and in reality objects may have multiple such dependency levels. FIG. 7 shows a package comprising multi-level object dependencies.

FIG. 8 shows a package comprising a user object and its impact upon other objects (Role; Team) of a package.

A package that is created may include objects having dependencies with other objects. Understanding and visualizing those dependencies can be useful to a user who is handling a package. Details regarding creation of a package according to this example, are now discussed.

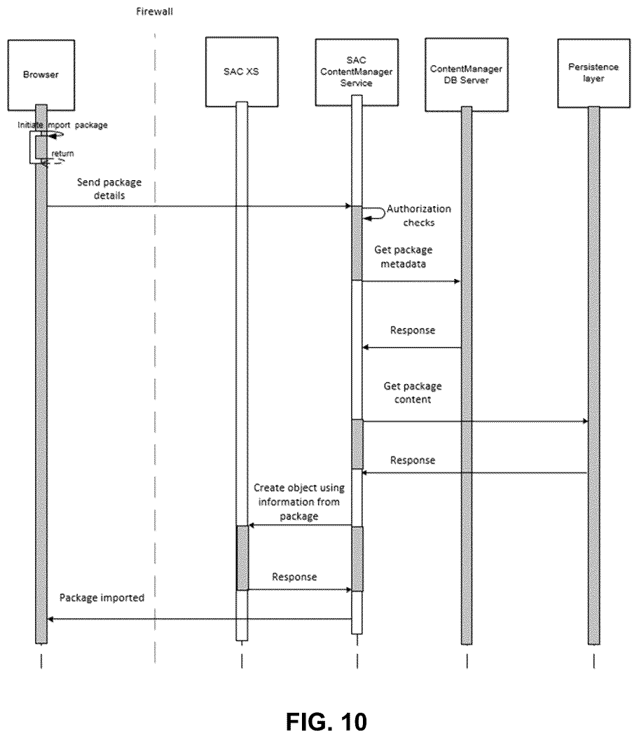

In order to create a package in SAC, the process shown in FIG. 9 is performed.
1. User clicks on “New Export” option to create a new package
2. Select objects like story, model, dimension, currency, roles, folder etc
3. Provide information like package name, description, details. Optionally share with destinations, selects Industry, LOB etc
4. Review package summary
5. Export package to create a new package

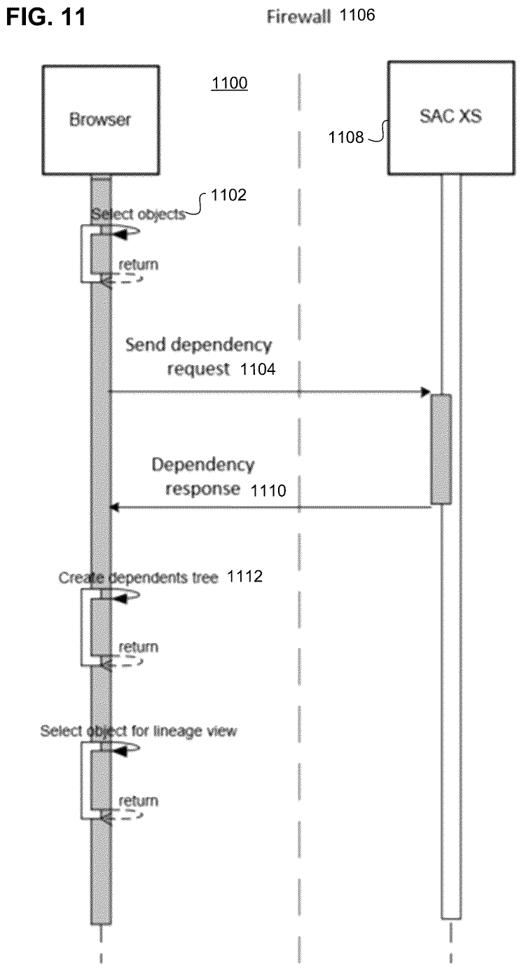

In order to import a package in SAC, the process shown in FIG. 10 is performed.
1. User clicks on package to be imported
2. Review package summary
3. Update import preferences and object location as needed
4. Trigger import.

If a user seeks to import only certain objects from within the packages, they are aware which objects to unselect, but they may not be aware of the dependent objects associated with the unselected objects.

While importing package in a target tenant, if there are any dependent object(s) missing in the package and missing in the target tenant, then embodiments can proactively warn users on the impact due to the missing dependent objects. This allows a user take corrective action before the import, and avoid failures (e.g., as shown in FIG. 1A).

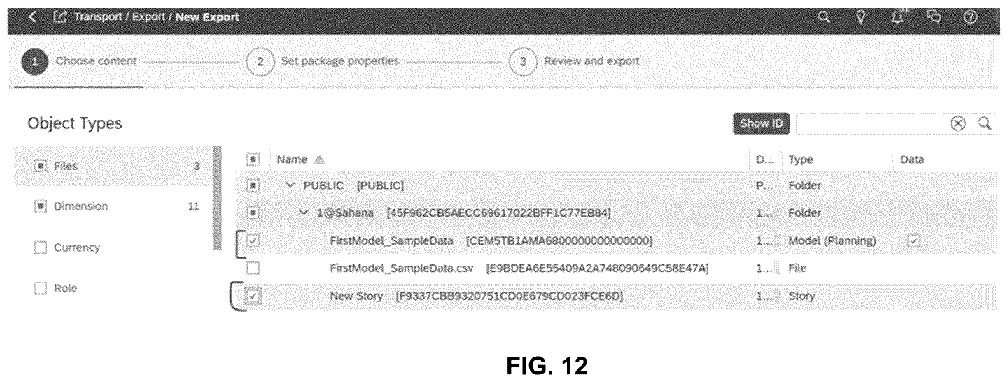

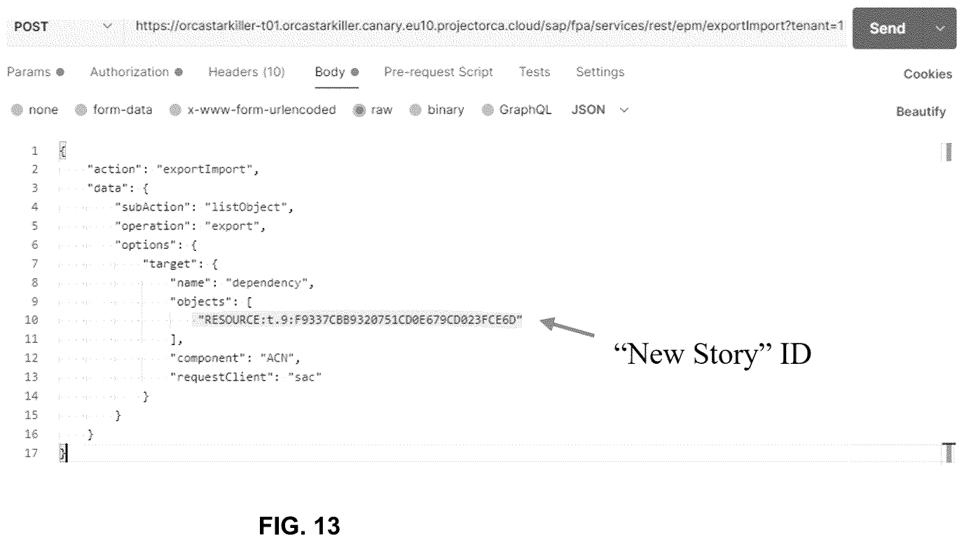

FIG. 11 is a simplified flow diagram 1100 illustrating actions in a lineage analysis according to an exemplary embodiment. First, at 1102, an object is selected. FIG. 12 is an example screenshot showing selection of a “New Story” object, with its dependents auto selected.

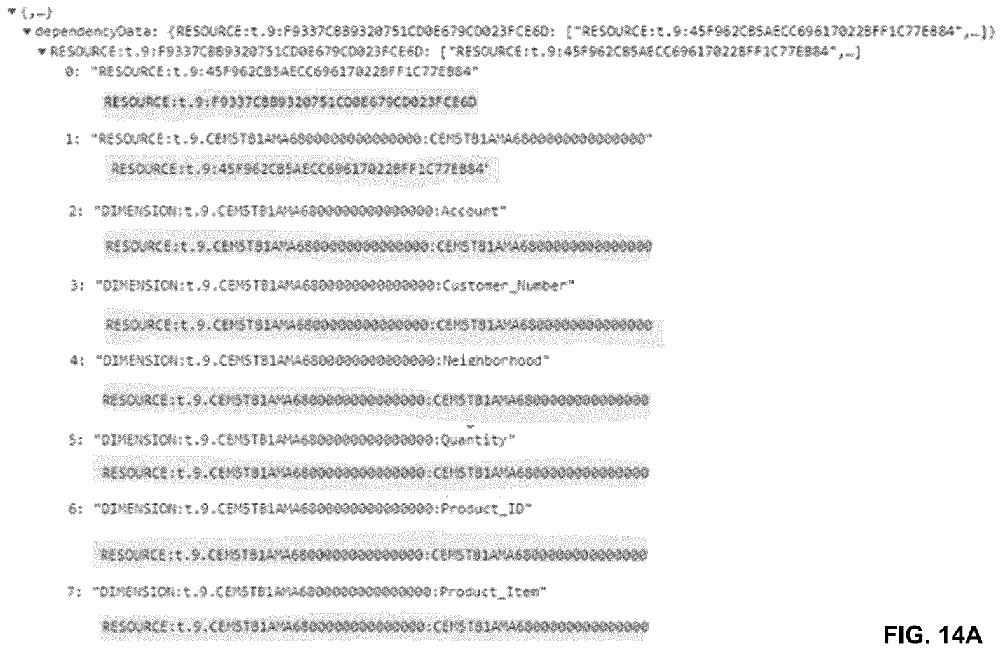

Then, a dependency calculation request 1104 is sent across the firewall 1106 to the ACN service 1108. FIG. 13 shows a dependency calculation request including the ID for the “New Story” object.

The ACN then processes the dependency calculation request to generate a dependency response 1110. The dependency response may be calculated according to the following procedure.
1. Send request to calculate selected object's dependency objects
2. ACN service:
   a. determines dependency objects for each selected object
   b. executes step 2.a recursively for each dependency object.

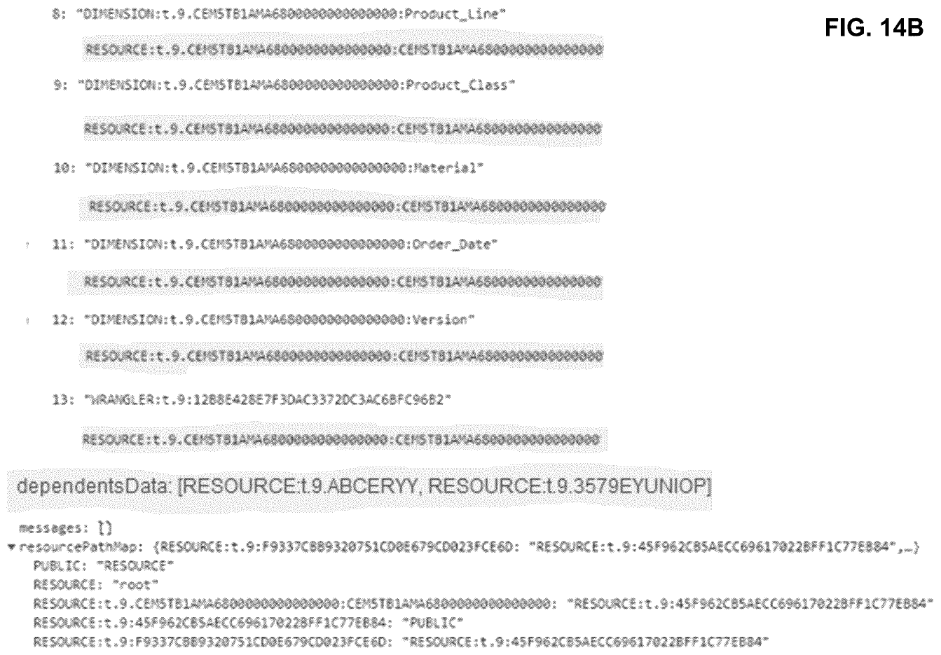

Then, the ACN forwards the dependency response back across the firewall. FIGS. 14A-B shows a dependency calculation response which includes highlighted dependents for each object. The dependency calculation response provides dependentData in addition to dependencyData.

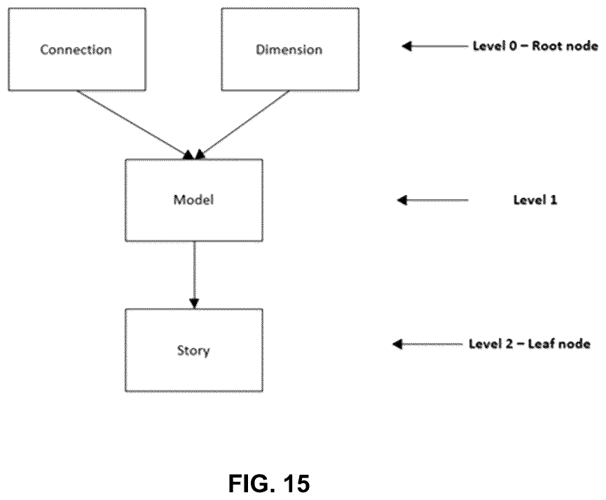

Next, using the dependency calculation response,
3. a tree structure 1112 is created (FIG. 15).
   a. Each node ‘X’ has dependents information
   b. Each dependencyData contains dependent information (from e.g., FIGS. 14A-B).
   c. Using dependent information, we create/update nodes in the tree structure.
   d. Repeat Step a-c upon each object selection by user

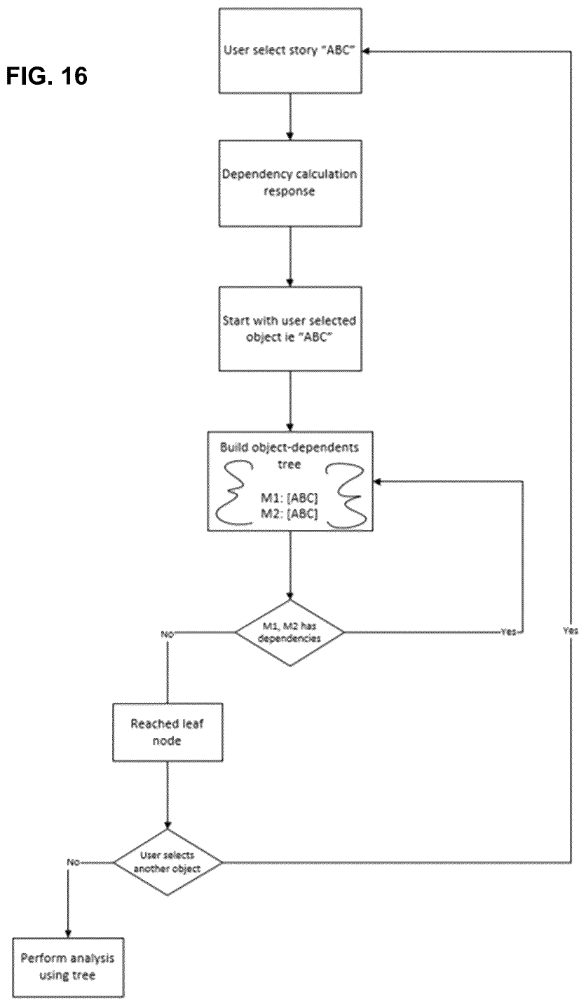

One specific example is now described in connection with FIG. 16. Here, an “ABC” story object comprises dimensions (D1, D2, D3, D4), Models (M1 and M2), and connections (C1 and C2).

As shown in the flow diagram of FIG. 16, an object-dependent tree is created by the following.
1. User selected story “ABC”
2. A new dependency calculation response
3. currentNode=ABC
4. Check for its dependency objects:
   a. Update the tree:
      i. Create node if doesn't exist; here ABC, M1, M2 nodes are created
      ii. update node if already exists
   b. assign currentNode ie “ABC” as M1, M2 dependent:
      i. dependencyObject: [dependents] structure will be created
      ii. here 2 nodes created ie., M1: [ABC] and M2: [ABC]
   c. Now determine M1, M2 dependency objects
   d. Repeat step 3-4 until leaf object reached
5. User selects another object repeat step 1-5
6. Once user completes selection, user can perform lineage analysis

A visual representation of the downward dependency in the tree is useful to afford lineage views. The representation of the impacted objects could be achieved through the use of a spider chart.

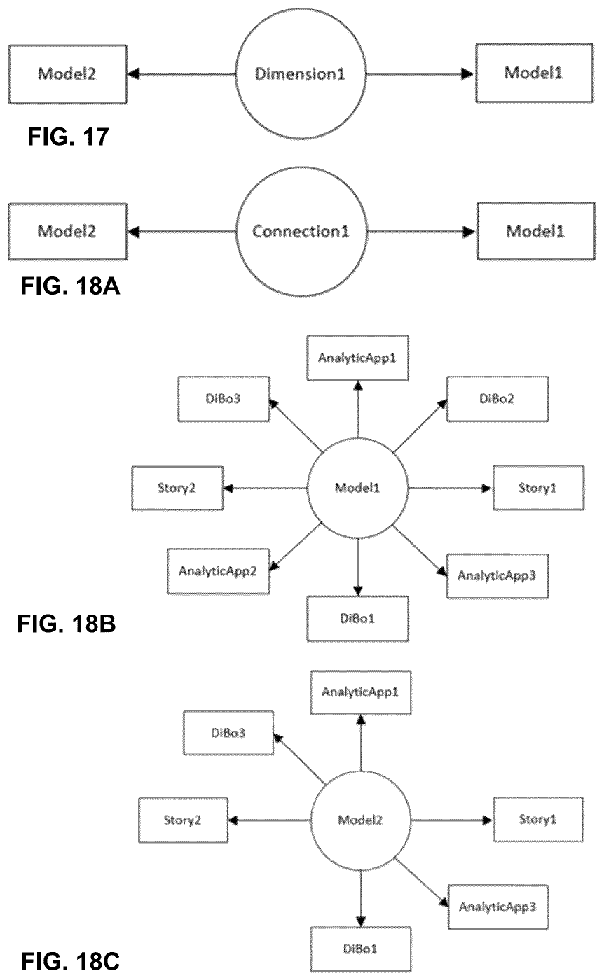

Taking, for example the spider chart of FIG. 17, the object ‘Dimension 1’ is selected for lineage analysis of the impact would be in the center of the spider web. The impacted objects would be placed at the nodes of the web going outwards from the center.

User would be able to perform impact analysis for any object in the chart. On double clicking any object in chart, that object would become the center of analysis and the impacted objects will be determined from tree structure for this new object in the center.

FIG. 17 is a spider chart showing D1 dependents. FIG. 18A is a spider chart showing C1 dependents. FIG. 18B is a spider chart showing M1 dependents. FIG. 18C is a spider chart showing M2 dependents.

This style of visualization could permit a user to readily identify impacted dependent objects in the downward direction, and makes possible analysis of multiple objects.

Returning now to FIG. 1, there the particular embodiment is depicted with the lineage engine as being located outside of the database that is storing the dependencies result. However, this is not required.

Rather, alternative embodiments could leverage the processing power of an in-memory database engine (e.g., the in-memory database engine of the HANA in-memory database available from SAP SE), in order to perform various functions as described above.

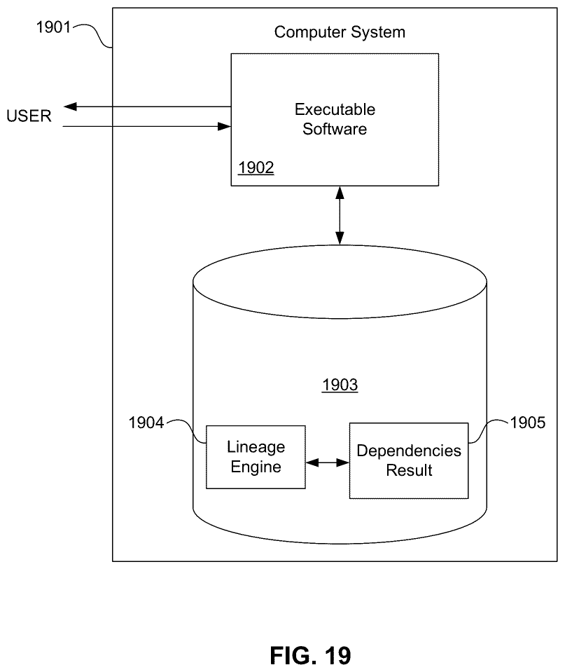

Thus FIG. 19 illustrates hardware of a special purpose computing machine configured to perform lineage analysis for object transport according to an embodiment. In particular, computer system 1901 comprises a processor 1902 that is in electronic communication with a non-transitory computer-readable storage medium comprising a database 1903. This computer-readable storage medium has stored thereon code 1905 corresponding to a lineage engine. Code 1904 corresponds to a dependency result. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

It is noted that the ability to perform lineage analysis according to embodiments, offers a number of potential benefits. For example, a user is afforded an overall picture of an object and its dependencies. This is dependency management.

Moreover embodiments can help a user to understand the impact an object has on its dependencies. This is impact analysis. In one possible example, embodiments could help a user understand that updating a single model object will in turn impact five different story objects.

Embodiments allow a user to be cautious while changing an object. That is, the user may be forewarned that changing one object may affect a large number of other, dependent objects.

In content transportation scenarios, lineage and impact analysis can help user to make informed decisions, e.g.:

whether to include an object during export or not—helps determine if import will be successful or not; thus, increasing success rate of import by identifying dependency issues during export itself (see FIG. 1A); and/or whether to include an object during export or not—helps to reduce export and import time and/or export package size (see FIG. 1B).

Embodiments may also aid a user in conforming to export size limits. For example, exported packages will be saved in persistence layer in cloud. However, each tenant may be allocated a fixed limit (e.g., 300 MB) of cloud storage space by default, with storage beyond this entailing additional costs. Hence, if embodiments allow a user to choose only objects that are really needed, available storage space will be used more efficiently and costs can be reduced.

Lastly, embodiments offer flexibility and convenience to a user. In particular a single click solution is provided to visualize relationship mapping between objects. This makes management or maintenance of the objects more simple.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented system and methods comprising:
receiving an input identifying a content object present in a landscape;
in response to the input, referencing a hierarchical structure including the content object and a dependent content object, to create a first visualization including the content object and the dependent content object;
receiving another input to the first visualization identifying the dependent content object; and in response to the another input, referencing the hierarchical structure to create a second visualization including the dependent content object and another dependent content object that is dependent from the dependent content object in the landscape.

Example 2. The computer implemented system and method of Example 1 further comprising prior to receiving the input:
receiving a dependency response from the landscape;
storing the dependency response as a dependencies result in a non-transitory computer readable storage medium; and
constructing the hierarchical structure from the dependencies result.

Example 3. The computer implemented system and method of Example 2 further comprising prior to receiving the dependency response:
receiving a selected object in the landscape; and
communicating to the landscape, a dependency request including the selected object.

Example 4. The computer implemented system and method of Example 2 wherein the dependencies result comprises a table in a database of the non-transitory computer readable storage medium.

Example 5. The computer implemented system and method of Example 4 wherein: the database comprises an in-memory database including an in-memory database engine; and the in-memory database engine constructs the hierarchical structure from the dependencies result.

Example 6. The computer implemented system and method of Example 1, 2, 3, 4, or 5 wherein the hierarchical structure comprises a tree including a root node and a leaf node.

Example 7. The computer implemented system and method of Examples 1, 2, 3, 4, 5, or 6 wherein:
the first visualization comprises a first spider chart having the content object at a center, and
the dependent content object at a periphery; and
the second visualization comprises a second spider chart having the dependent object at a center, and the another dependent content object at a periphery.

Example 8. The computer implemented system and method of Examples 1, 2, 3, 4, 5, 6, or 7 wherein the content object comprises a model, a story, or a dimension.

Example 9. The computer implemented system and method of Examples 1, 2, 3, 4, 5, 6, 7, or 8 further comprising including the content object in a package, and transporting the package.

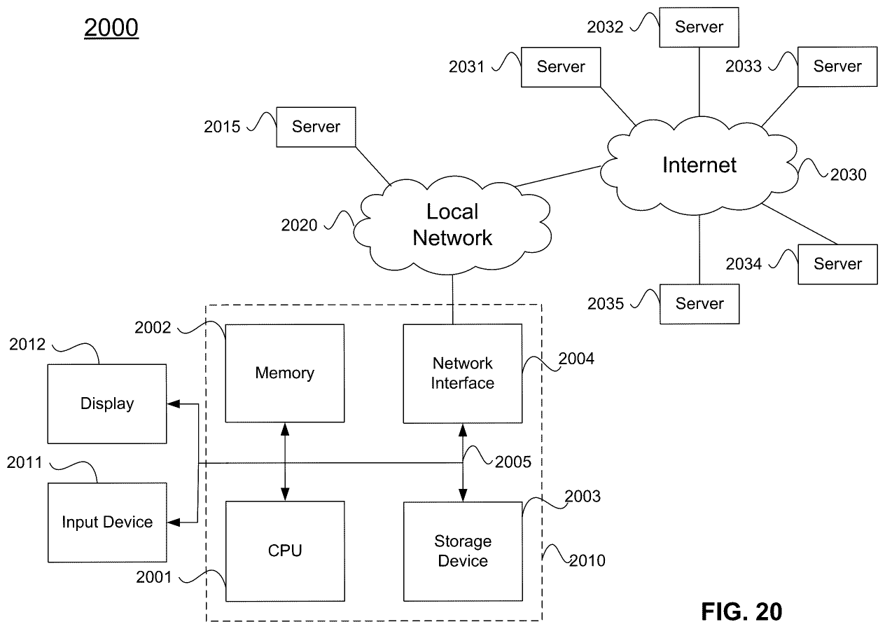

An example computer system 2000 is illustrated in FIG. 20. Computer system 2010 includes a bus 2005 or other communication mechanism for communicating information, and a processor 2001 coupled with bus 2005 for processing information. Computer system 2010 also includes a memory 2002 coupled to bus 2005 for storing information and instructions to be executed by processor 2001, including information and instructions for performing the techniques described above, for example. This memory may also be used for storing variables or other intermediate information during execution of instructions to be executed by processor 2001. Possible implementations of this memory may be, but are not limited to, random access memory (RAM), read only memory (ROM), or both. A storage device 2003 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 2003 may include source code, binary code, or software files for performing the techniques above, for example. Storage device and memory are both examples of computer readable mediums.

Computer system 2010 may be coupled via bus 2005 to a display 2012, such as a Light Emitting Diode (LED) or liquid crystal display (LCD), for displaying information to a computer user. An input device 2011 such as a keyboard and/or mouse is coupled to bus 2005 for communicating information and command selections from the user to processor 2001. The combination of these components allows the user to communicate with the system. In some systems, bus 2005 may be divided into multiple specialized buses.

Computer system 2010 also includes a network interface 2004 coupled with bus 2005. Network interface 2004 may provide two-way data communication between computer system 2010 and the local network 2020. The network interface 2004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 2004 sends and receives electrical, electromagnetic, or optical signals that carry digital data streams representing various types of information.

Computer system 2010 can send and receive information, including messages or other interface actions, through the network interface 2004 across a local network 2020, an Intranet, or the Internet 2030. For a local network, computer system 2010 may communicate with a plurality of other computer machines, such as server 2015. Accordingly, computer system 2010 and server computer systems represented by server 2015 may form a cloud computing network, which may be programmed with processes described herein. In the Internet example, software components or services may reside on multiple different computer systems 2010 or servers 2031-2035 across the network. The processes described above may be implemented on one or more servers, for example. A server 2031 may transmit actions or messages from one component, through Internet 2030, local network 2020, and network interface 2004 to a component on computer system 2010. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A method comprising:
receiving an input identifying a content object present in a landscape;
in response to the input, referencing a hierarchical structure including the content object and a dependent content object, to create a first visualization including the content object and the dependent content object;
receiving another input to the first visualization identifying the dependent content object; and
in response to the another input, referencing the hierarchical structure to create a second visualization including the dependent content object and another dependent content object that is dependent from the dependent content object in the landscape.

2. A method as in claim 1 further comprising, prior to receiving the input:
receiving a dependency response from the landscape;
storing the dependency response as a dependencies result in a non-transitory computer readable storage medium; and
constructing the hierarchical structure from the dependencies result.

3. A method as in claim 2 wherein the dependencies result comprises a table in a database of the non-transitory computer readable storage medium.

4. A method as in claim 3 wherein:
the database comprises an in-memory database including an in-memory database engine; and
the in-memory database engine constructs the hierarchical structure from the dependencies result.

5. A method as in claim 2 further comprising, prior to receiving the dependency response:
receiving a selected object in the landscape; and
communicating to the landscape, a dependency request including the selected object.

6. A method as in claim 1 wherein the hierarchical structure comprises a tree including a root node and a leaf node.

7. A method as in claim 1 wherein:
the first visualization comprises a first spider chart having the content object at a center, and the dependent content object at a periphery; and
the second visualization comprises a second spider chart having the dependent object at a center, and the another dependent content object at a periphery.

8. A method as in claim 1 wherein the content object comprises a model, a story, or a dimension.

9. A method as in claim 1 further comprising:
including the content object in a package; and
transporting the package.

10. A non-transitory computer readable storage medium embodying a computer program for performing a method, said method comprising:
receiving an input identifying a content object present in a landscape;
in response to the input, referencing a hierarchical structure including the content object and a dependent content object, to create a first visualization including the content object and the dependent content object;
receiving another input to the first visualization identifying the dependent content object; and
in response to the another input, referencing the hierarchical structure to create a second visualization including the dependent content object and another dependent content object that is dependent from the dependent content object in the landscape,
wherein the method further comprises,
prior to receiving the input,
receiving a dependency response from the landscape;
storing the dependency response as a dependencies result in a non-transitory computer readable storage medium; and
constructing the hierarchical structure from the dependencies result.

11. A non-transitory computer readable storage medium as in claim 10 wherein the dependencies result comprises a table in a database of the non-transitory computer readable storage medium.

12. A non-transitory computer readable storage medium as in claim 10 wherein the hierarchical structure comprises a tree including a root node and a leaf node.

13. A non-transitory computer readable storage medium as in claim 10 wherein:
the first visualization comprises a first spider chart having the content object at a center, and the dependent content object at a periphery; and
the second visualization comprises a second spider chart having the dependent object at a center, and the another dependent content object at a periphery.

14. A non-transitory computer readable storage medium as in claim 10 wherein the content object comprises a model, a story, or a dimension.

15. A computer system comprising:
one or more processors;
a software program, executable on said computer system, the software program configured to cause an in-memory database engine of an in-memory database to:
receive an input identifying a content object present in a landscape;
in response to the input, reference a hierarchical structure including the content object and a dependent content object, to create a first visualization including the content object and the dependent content object;
receive another input to the first visualization identifying the dependent content object; and
in response to the another input, reference the hierarchical structure to create a second visualization including the dependent content object and another dependent content object that is dependent from the dependent content object in the landscape,
wherein prior to receiving the input, the in-memory database engine is further configured to,
receive a dependency response from the landscape;
store the dependency response as a dependencies result in the in-memory database; and
construct the hierarchical structure from the dependencies result.

16. A computer system as in claim 15 wherein prior to receiving the dependency response, the in-memory database engine is further configured to:
receive a selected object in the landscape; and
communicate to the landscape, a dependency request including the selected object.

17. A computer system as in claim 15 wherein the hierarchical structure comprises a tree including a root node and a leaf node.

18. A computer system as in claim 15 wherein:
the first visualization comprises a first spider chart having the content object at a center, and the dependent content object at a periphery; and
the second visualization comprises a second spider chart having the dependent object at a center, and the another dependent content object at a periphery.

19. A computer system as in claim 15 wherein the content object comprises a model, a story, or a dimension.

20. A computer system as in claim 15 wherein the in-memory database engine is further configured to transport a package comprising the content object.
